(19) United States
(12) Patent Application Publication
(10) Pub. No.: US 2025/0338923 A1
(43) Pub. Date: Nov. 6, 2025

(54) BELT BUCKLE FOR REMOVABLY HOLDING A FOLDING KNIFE

(71) Applicant: Benjamin Williams, Hamilton, MT (US)

(72) Inventor: Benjamin Williams, Hamilton, MT (US)

(21) Appl. No.: 19/196,709

(22) Filed: May 1, 2025

Related U.S. Application Data
(60) Provisional application No. 63/641,425, filed on May 2, 2024.

(51) Int. Cl. A44B 11/00; A45F 5/00; A45F 5/02; B26B 1/02

(52) U.S. Cl. CPC A44B 11/005; A45F 5/021; A45F 5/1575; B26B 1/02; A44D 2203/00

(57) ABSTRACT

A belt buckle configured to removably retain a folding knife in a substantially concealed manner is provided. The belt buckle includes a first sidewall and a second sidewall that are connected at their bottom end by a bottom wall. A groove is formed due to the strategic arrangement of the first sidewall, the second sidewall, and the bottom wall. The groove is dimensioned to receive and retain a blade of the folding knife. The groove includes magnet(s) to magnetically attract the blade of the folding knife. The belt buckle holds the folding knife in place securely and also assists in selectively deploying the blade of the folding knife in either an open or a closed position.

### CROSS-REFERENCE TO RELATED PATENT DOCUMENTS

This patent application claims the benefit of priority of U.S. Provisional Application No. 63/641,425, entitled “A BELT BUCKLE FOR REMOVABLY HOLDING A FOLDING KNIFE,” filed May 2, 2024, which is hereby incorporated herein by reference in its entirety.

### FIELD OF THE INVENTION

The present invention relates to the field of belt buckles, and more particularly, the present invention relates to a belt buckle for removably holding a folding knife that involves the use of magnetic force to retain the knife in a folded position.

### BACKGROUND

Generally, people carry pocket knives in their pockets for various purposes, such as but not limited to package opening, fishing, slicing fruits, boring holes in soft material, self-protection, and so on. A pocket knife is also referred to as a jack-knife, folding knife, EDC knife, and penknife and includes one or more blades that pivotably fold into the handle. Also, few individuals often carry knives of the fixed-blade type hanging at their side in a sheath attached to their belt.

The fixed-blade knives cannot be easily reached by either hand, or the user can accidentally injure themselves while removing the fixed-blade knife from the sheath. Further, the fixed-blade knives in the sheath are often not concealed, and any non-user (third-party) can identify and see the fixed-blade knife when the fixed-blade knife is positioned in the sheath attached to their belt.

The pocket knife is usually carried by the user inside the pocket of their pants. However, the user can change pants during the day/night depending on their requirements, and thus, the pocket knife kept in the pocket of the pants can be easily forgotten by the user. When the folding knife is in its folded position, the folding knife can result in a rather large mass in a pocket, which can lead to discomfort for the user while the user is performing daily tasks. Further, the pocket knife remains folded when it is removed from a pocket, thereby requiring an additional operation in addition to withdrawing the knife from the pocket to place the pocket knife blade in an open deployed position.

Pocket clips are well-known in the art that serves to attach the pocket knife to the pocket in either a single orientation or multiple orientations. However, the pocket clips can potentially break (tear) down the pocket. Further, the pocket clips are easily seen by non-users. Further, the pocket knife clip can get caught and bent/broken while the user is doing everyday activities. Once the pocket clip gets bent or broken, it is no longer functional and must go directly into the pocket of the user, which increases time and utilizes a substantial effort to retrieve the pocket clip.

Various solutions exist in the prior art that serve to assist the user in carrying a folding (pocket) knife. For instance, U.S. Pat. No. 4,494,310A discloses a belt buckle in which a knife portion can be removed with the knife blade locked in its open position without the need to remove the belt buckle knife from the belt. The belt buckle knife includes a buckle portion that engages and fastens the belt independently of the knife portion. The knife portion is selectively operable from a folded position to an open position. In the folded position, the knife blade is engaged by an open tapered groove running along the length of the buckle portion, with the knife portion and the buckle portion being securely fastened together. In the open position, the knife blade is locked open to the knife handle, and the knife portion can readily be removed from the buckle portion.

However, the U.S. Pat. No. 4,494,310A has a few drawbacks. U.S. Pat. No. 4,494,310A discloses that the buckle structure includes a blade receiving groove. When the knife structure is in its folded or open position, the blade receiving groove engages the blade member securely fastening the knife structure and the buckle structure together. However, the blade receiving groove, alone is not capable of effectively fastening the knife structure and the buckle structure together as the blade member can come out of the groove when the user is performing daily tasks such as running, jumping, bending, and so on. Further, when the belt buckle knife is removed from the buckle portion, then the belt buckle knife can only be withdrawn (removed) in an open position.

The existing solutions related to assisting the user in carrying pocket knives are inefficient and ineffective, complex in use, do not conceal pocket knives, and can damage the clothing of the user. There is a need for an effective and efficient solution that solves the aforementioned problem by providing a belt buckle and a folding knife combination that involves the use of magnetic force to retain the folding knife in a closed position and selectively deploy the folding knife in either: an open position and a closed position depending on the requirements of the user.

### SUMMARY

An object of the present invention is to provide a belt buckle that effectively and efficiently retains a folding knife in a closed position and deploys the folding knife in either an open position or a closed position depending on the requirements of the user.

An object of the present invention is to provide a belt buckle that serves the purpose of providing a tightening effect (securing) for the lower body clothing of the user as well as effectively retaining the folding knife in the closed position.

An object of the present invention is to provide a belt buckle that can be used several times during the lifetime of the belt buckle.

Another object of the present invention is to provide a belt buckle that substantially conceals the folding knife.

Another object of the present invention is to provide a belt buckle and a folding knife combination that substantially resembles a conventional belt buckle to a non-user due to the puzzle-like fitting of the folding knife and the belt buckle.\

An object of the present invention is to provide a belt buckle that continues to function similarly to that of a conventional belt buckle when the folding knife is removed from the belt buckle.

An object of the present invention is to provide a belt buckle and a folding knife combination that involves the use of magnetic force to retain the folding knife in a closed position in a more effective manner.

An object of the present invention is to provide a belt buckle that can be connected to various surfaces.

While the way that the present disclosure addresses the disadvantages of the prior art will be discussed in greater detail below, in general, the present disclosure provides A belt buckle having a first sidewall and a second sidewall connected at their bottom ends by a bottom wall. The belt buckle further includes a groove formed by the connection arrangement of the first sidewall, the second sidewall, and the bottom wall. The groove is dimensioned to receive and magnetically retain a folding knife in a folded position. The groove includes at least one magnet to magnetically attract a blade of the folding knife.

In an embodiment, the belt buckle further includes a fastener removably connectable to a conventional belt. the fastener may include a tongue configured to be slidably inserted into a selective hole of the conventional belt to achieve the desired tightening of the conventional belt around the waist of a user.

In an embodiment, the at least one magnet is disposed on at least one of the first sidewall, the second sidewall, and the bottom wall of the belt buckle.

In an embodiment, the first sidewall comprises a semicircular cut-out portion to enable the user to grip the folding knife.

In an embodiment, the first sidewall comprises a magnetic wall to magnetically attract the blade of the folding knife in the folded position.

In an embodiment, the blade of the folding knife is formed of a ferromagnetic material that's magnetically attracted to the at least one magnet of the belt buckle, thereby enabling the retention of the folding knife within the groove of the belt buckle.

These and other features and advantages of the present invention will become apparent from the detailed description below, in light of the accompanying drawings.

### BRIEF DESCRIPTION OF THE DRAWINGS

A more complete understanding of the present disclosure may be derived by referring to the detailed description and claims when considered in connection with the figures, wherein like reference numerals refer to similar elements throughout the figures, and

FIG. 1 illustrates a front-perspective view of a belt buckle and a folding knife combination in a folded position, according to an embodiment of the present invention.

FIG. 2 illustrates a front view of the belt buckle and the folding knife combination of FIG. 1.

FIG. 3 illustrates a back view of the belt buckle of FIG. 1.

FIG. 4 illustrates a front view of the belt buckle of FIG. 1.

FIG. 5 illustrates a perspective top view of the belt buckle of FIGS. 3-4.

FIGS. 6-7 illustrate various views of the belt buckle and the folding knife combination, wherein the folding knife is shown in an open position and is shown removed from the belt buckle for the sake of simplicity and ease of understanding.

FIG. 8 illustrates a user carrying the folding knife in the belt buckle of FIG. 1, according to an embodiment of the present invention.

FIG. 9 illustrates a user removing the folding knife from the belt buckle of FIG. 1, with the folding knife in a folded position.

FIG. 10 illustrates a user removing the folding knife from the belt buckle of FIG. 1, with the folding knife in a semi-open position.

### DETAILED DESCRIPTION

The following description is of exemplary embodiments of the invention only and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms, and the like and still fall within the scope of the present invention. Thus, the detailed description herein is presented for purposes of illustration only and not for limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

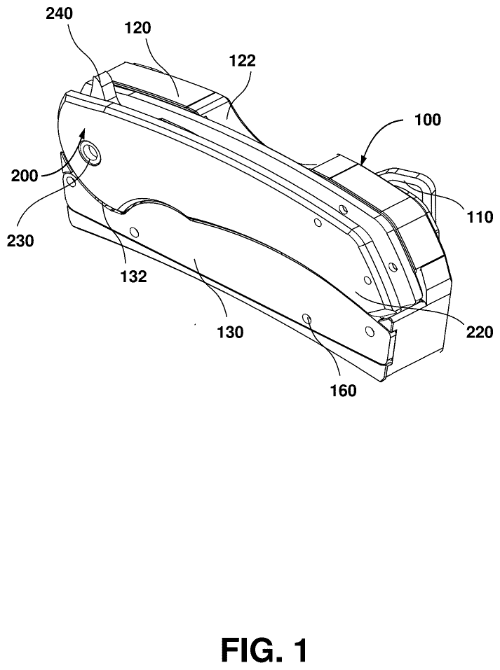

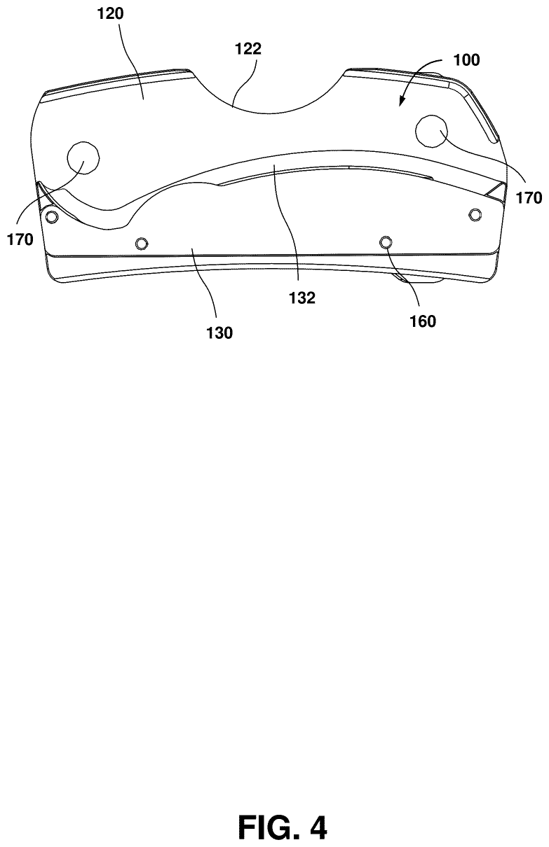

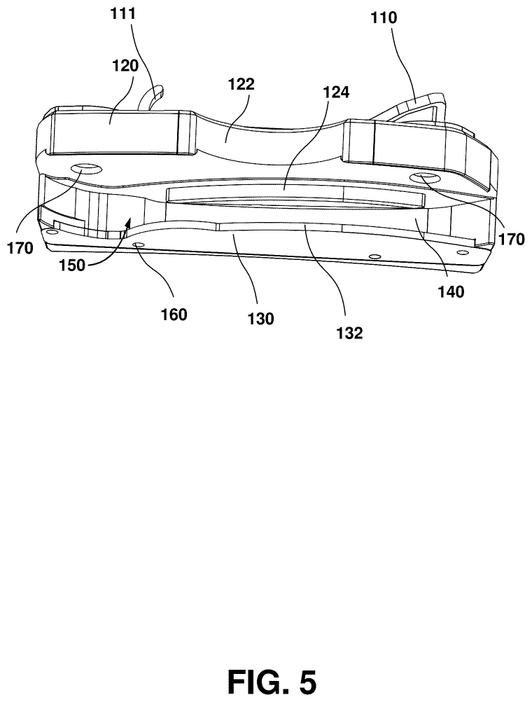

The belt buckle and the folding knife combination will now be described with reference to the accompanying drawings, particularly FIGS. 1-10.

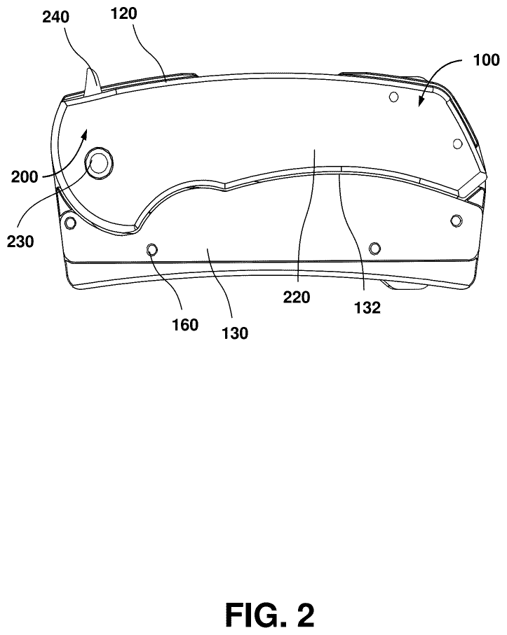

Reference is initially made to FIGS. 1-2 that illustrate a first front-perspective view and a front view of a belt buckle 100, respectively, according to an embodiment of the present invention. The belt buckle 100 is configured to removably hold (retain) a folding knife 200 in a substantially concealed manner, the entirety of which will be described in greater detail in the description below.

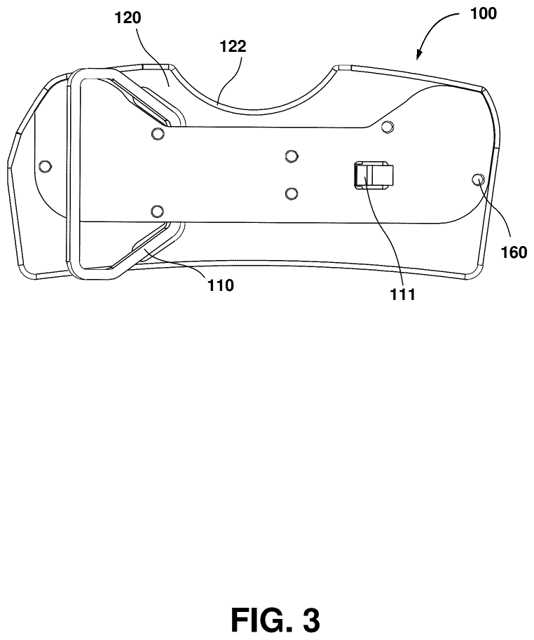

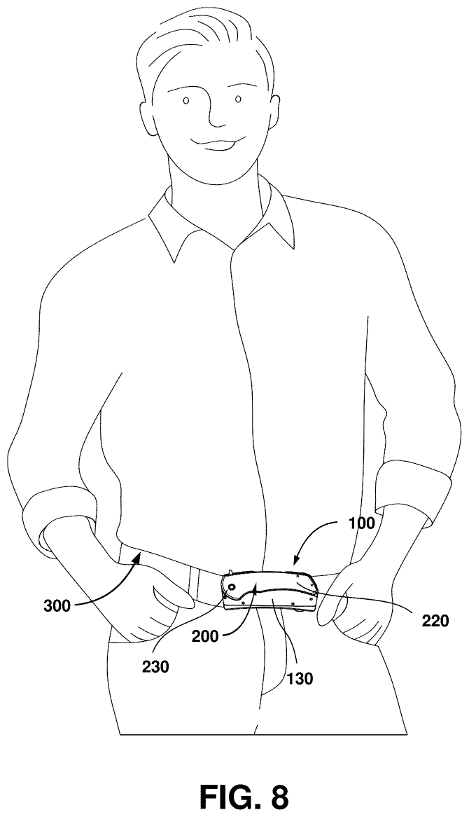

Referring to FIGS. 3-5, the belt buckle 100 is configured to be removably attached to a conventional belt 300 (FIGS. 8-10) using a fastener 110 already known in the art. In an embodiment as seen in FIG. 3, the fastener 110 includes a hook and loop fastener that removably connects the belt buckle 100 to the conventional belt 300. In various other embodiments, the fastener 110 can include, but is not limited to, snap-fit fastener, harness fasteners, threaded fasteners, tooth-type fasteners, side release fasteners, clip-on fastener, prong-type fastener, glue, and so on. Further, the belt buckle 100 can also be permanently connected to a conventional belt 300, using any conventional methods/techniques already known in the art, such as but not limited to: stitching, riveting, welding, and so on. The fastener 110 includes a tongue 111 that is configured to be slidably inserted into any selected hole of the conventional belt 300 to achieve the desired tightening of the conventional belt 300 around the waist of the user.

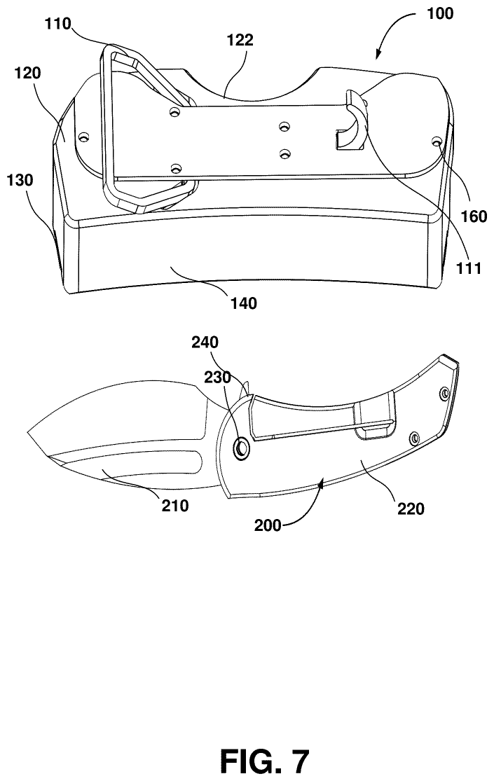

The belt buckle 100 includes a first sidewall 120 and a second sidewall 130. The first sidewall 120 and the second sidewall 130 are connected at their bottom ends by a bottom wall 140. The bottom wall 140 is configured to support the load (weight) of the folding knife 200. A groove 150 is formed (defined) due to the connection arrangement of the first sidewall 120, the second sidewall 130, and the bottom wall 140. The groove 150 is dimensioned to receive a blade 210 (FIG. 7) of the folding knife 200 (FIGS. 1-2) when the folding knife is in a folded position. In an embodiment, the groove 150 includes at least one magnet such that the magnet(s) of the groove 150 magnetically attracts the folding knife 200, in particular, the blade 210 of the folding knife 200. The magnet(s) can be disposed of (positioned) in at least one of the: the first sidewall 120, the second sidewall 130, and the bottom wall 140. The purpose of the magnet(s) is to hold the folding knife 200 in place securely and also assist in the self-deployment of the blade 210 of the folding knife 200 in an opened position.

In an embodiment as seen in FIGS. 3-5, the first sidewall 120 includes a semicircular cut-out portion 122 to enable the user to grip the folding knife 200 (FIGS. 1-2) using their hands more effectively. In an embodiment as seen in FIGS. 3-5, the first sidewall 120 includes a magnetic wall 124 that is configured to magnetically attract the folding knife 200, in particular, the blade 210 of the folding knife 200. The second sidewall 130 comprises an edge 132 that is configured to at least partially support the weight placement of the handle 220 (of the knife 200) on edge 132 of the second sidewall 130. Further, the first sidewall 120 and/or the second sidewall 130 comprise a plurality of mini-holes 160. Further, the first sidewall 120 includes a pair of circular holes 170.

It should be understood that the number and arrangement of the magnet(s) can be varied depending on the needs of the user. In an exemplary embodiment (not shown in figures), multiple magnets may be disposed in at least one of or in combination in the first sidewall 120, the second sidewall 130, and the bottom wall 140. The magnets are arranged in any pattern, such as but not limited to an array pattern, a circular pattern, and so on. Broadly speaking, the number of magnets and the arrangement of the magnets is not limiting factors of the present invention.

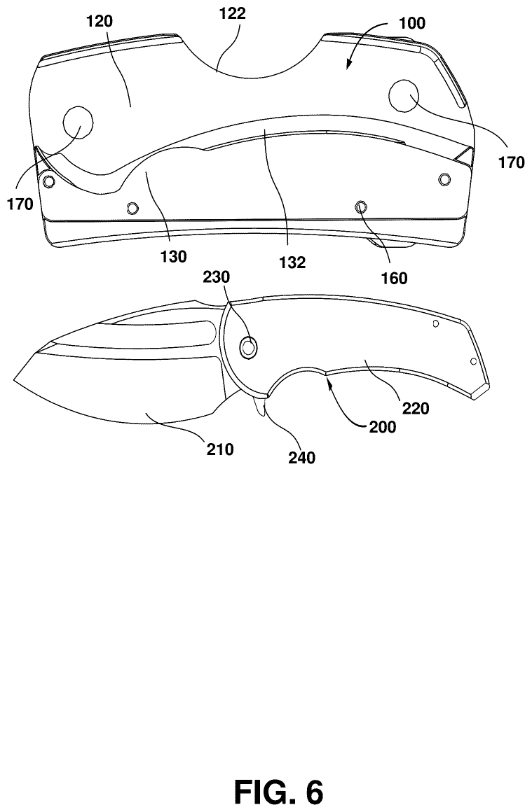

Referring to FIGS. 6-7, the folding knife 200 is any pocket knife known in the art, and the folding knife 200 includes a blade 210 that is rotatably connected to a handle 220 by a pivot pin 230. The blade 210 can be selectively deployed by a user in either of two positions, that is, in an opened position in which the blade 210 extends from the handle 220 as seen in FIGS. 6-7, and a folded position in which the blade 210 is at least partially folded (retained) in the handle 220 by pressing a lever 240 (located on the handle 220), as seen in FIGS. 1-2 and FIGS. 8-9. The lever 240 is located on the handle 220. The blade 210 can include at least one ferromagnetic element, or the blade 210 can be formed of a ferromagnetic material such as, but not limited to: steel, iron, nickel, and cobalt, and combinations/alloys thereof. The ferromagnetic property of blade 210 enables the blade 210 to be magnetically attracted to the magnet(s) of the belt buckle 100, thereby enabling the effective retaining of the folding knife 200 in the belt buckle 100.

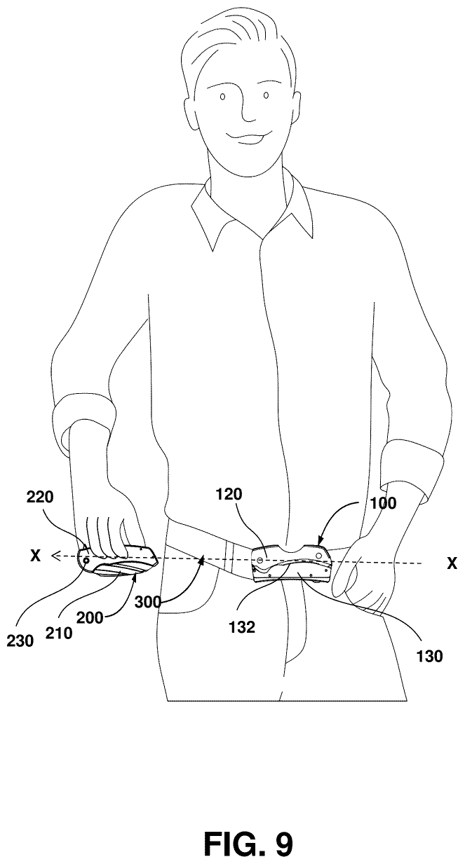

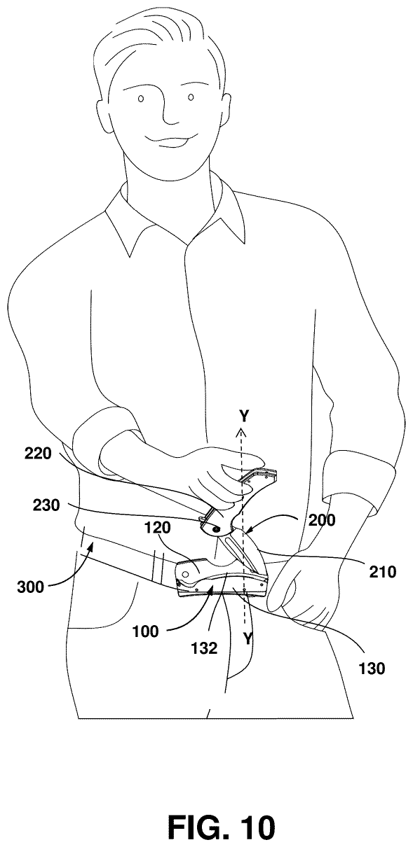

FIG. 8 illustrates a user carrying a folding knife 200 in the belt buckle 100, according to an embodiment of the present invention. The folding knife 200 and the belt buckle 100 are dimensioned such that the folding knife 200 is carried (locked) in the belt buckle 100 in a puzzle-fitting type manner. The folding knife 200 and the belt buckle 100 combination looks (resembles) a conventional belt buckle to a non-user (third party person excluding the user) due to the puzzle-like fitting of the folding knife 200 and the belt buckle 100. The blade 210 of the folding knife 200 becomes flush (parallel) to the second sidewall 130 as seen in FIG. 1 to provide a substantially smooth (seamless) outer surface (the surface facing opposite to the user) of the belt buckle 100. The non-user (third-party person) can only see the handle 220 of the folding knife 200 and interprets (visualizes) it as a component of a conventional belt buckle and thus, cannot easily identify (distinguish) that the belt buckle 100 is carrying the folding knife 200. Referring to FIGS. 9 and 10, when the folding knife 200 is removed from the belt buckle 100, the belt buckle 100 continues to function in a similar manner to that of a conventional belt buckle. Thus, the belt buckle 100 continues to securely and tightly hold the lower body clothing, such as but not limited to: pants, trousers, nikker, shorts, underwear, skirt, and so on, of the user irrespective of the positioning of the folding knife 200.

Referring to FIG. 9, a user can grip the handle 220 of the folding knife 200 and then move his/her hand in a substantially straight direction X-X (denoted by dotted lines and pointing arrow) to deploy the folding knife 200 in a folded position (FIGS. 1-2). The direction X-X (denoted by dotted lines and pointing arrow) substantially corresponds to the longitudinal axis of the belt buckle 100. FIG. 9 illustrates a user removing the folding knife 200 from the belt buckle 100 while moving their hands substantially in a direction X-X (denoted by dotted lines and a pointing arrow), wherein the folding knife 200 is in a folded position. The blade 210 is magnetically connected to the groove 150 while the user is moving the handle 220 using his/her hand by applying a force greater than and in the opposite direction of the magnetic attractive force between the blade 210 of the folding knife 200 and the groove 150 substantially in a direction X-X (denoted by dotted lines and pointing arrow). Afterward, the user can deploy the folding knife 200 from the folded position to the open position by pressing the lever 240 of the folding knife 200.

Referring to FIG. 10, a user can grip the handle 220 of the folding knife 200 and then move his/her hand substantially in a direction Y-Y (denoted by dotted lines and pointing arrow) to deploy the folding knife 200 in an open position (FIGS. 6-7), wherein the direction Y-Y (denoted by dotted lines and pointing arrow) is substantially perpendicular to the longitudinal axis of the belt buckle 100. FIG. 10 illustrates a user removing the folding knife 200 from the belt buckle 100, wherein the folding knife 200 is in a semi-open position. The magnet(s) of the groove 150 provides the magnetic attractive force to the blade 210 of the folding knife 200. The blade 210 is magnetically connected to the groove 150 while the user is moving the handle 220 using his/her hand by applying a force greater than and in the opposite direction of the magnetic attractive force between the blade 210 of the folding knife 200 and the groove 150 substantially in a direction Y-Y (denoted by dotted lines and pointing arrow). Thus, the user can bring the folding knife 200 from the closed or folded position, as seen in FIG. 8 to the semi-open position as seen in FIG. 10, and finally to the open position (FIGS. 6-7), thereby enabling the folding knife 200 to self-deploy in the open position due to the magnetic connection of the folding knife 200 and the belt buckle 100.

The belt buckle 100 according to various embodiments of the present invention as seen in FIGS. 1-10 is configured to removably connect with a conventional belt 300. It should be understood that belt buckle 100 is configured to attach to any surface apart from the conventional belt 300. The belt buckle 100 according to various embodiments of the present invention as seen in FIGS. 1-10 includes at least one magnet in the belt buckle 100 and the folding blade 200 includes a ferromagnetic element/ferromagnetic material. However, it should be understood that the belt buckle 100 according to another embodiment of the present invention can include a magnet(s) in the belt buckle 100 and the folding blade 200 includes a magnet. However, it should be understood that the belt buckle 100 according to another embodiment of the present invention can include a ferromagnetic element/ferromagnetic material in the belt buckle 100 and the folding blade 200 includes a magnet. Broadly speaking, one of the belt buckle 100 and the folding blade 200 can include a magnet(s) that can be magnetically connected with a magnet(s)/ferromagnetic element/ferromagnetic material of the remaining component selected from the belt buckle 100 and the folding blade 200 to enable proper functioning of the belt buckle 100.

In an embodiment, the majority of the belt buckle 100 (excluding the magnet/magnetic material) is made of a material having sufficient strength and rigidity such as but not limited to steel, iron, copper, aluminum, wood, leather, plastic and so on. The belt buckle 100 can have any shape such as but not limited to: rectangle, square, circle, triangle, hexagon, pentagon, oval, and so on. The various components and parts of the various embodiments of the belt buckle 100 of the present invention are similar and interchangeable. Further, it should be understood that the components of the belt buckle 100 can be made of any material and any size.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention

Claims what is claimed is:

1. A belt buckle (100), comprising:
a first sidewall (120) and a second sidewall (130) connected at their bottom ends by a bottom wall (140);
a groove (150) formed by the connection arrangement of the first sidewall (120), the second sidewall (130), and the bottom wall (140), wherein the groove (150) is dimensioned to receive a folding knife (200) in a folded position; and
wherein the groove (150) includes at least one magnet to magnetically attract a blade (210) of the folding knife (200).

2. The belt buckle (100) of claim 1 further comprising a fastener (110) removably connectable to a conventional belt (300).

3. The belt buckle (100) of claim 2, wherein the fastener (110) includes a tongue (111) configured to be slidably inserted into a selective hole of the conventional belt (300) to achieve the desired tightening of the conventional belt (300) around the waist of a user.

4. The belt buckle (100) of claim 1, wherein the bottom wall (140) is configured to support the weight of the folding knife (200) removably retained in the belt buckle (100).

5. The belt buckle (100) of claim 1, wherein the at least one magnet is disposed on at least one of: the first sidewall (120), the second sidewall (130), and the bottom wall (140).

6. The belt buckle (100) of claim 1, wherein the at least one magnet attracts the folding knife (200) to securely hold in place and assist in the self-deployment of the blade (210) of the folding knife (200) in an opened position.

7. The belt buckle (100) of claim 1, wherein the first sidewall (120) comprises a semicircular cut-out portion (122) to enable the user to grip the folding knife (200).

8. The belt buckle (100) of claim 1, wherein the first sidewall (120) comprises a magnetic wall (124) to magnetically attract the blade (210) of the folding knife (200) in the folded position.

9. The belt buckle (100) of claim 1, wherein the second sidewall (130) comprises an edge (132) to at least partially support the weight of a handle (220) of the folding knife (200).

10. The belt buckle (100) of claim 1, wherein the blade (210) of the folding knife (200) is rotatably connected to a handle (220) by a pivot pin (230) and is selectively deployable in an opened position or the folded position by pressing a lever (240) located on the handle (220).

11. The belt buckle (100) of claim 1, wherein the blade (210) is formed of a ferromagnetic material that's magnetically attracted to the at least one magnet of the belt buckle (100), thereby enabling the retainment of the folding knife (200) within the groove (150) of the belt buckle (100).

12. The belt buckle (100) of claim 1, wherein the folding knife (200) when removed from the belt buckle (100), the belt buckle (100) without the folding knife (200) continues to function in a similar manner to that of conventional belt buckles.

13. The belt buckle (100) of claim 1, wherein the handle (220) of the folding knife (200) is gripped by the user and moved his/her hand in a substantially longitudinal axis of the belt buckle (100) to deploy the folding knife (200) in a folded position within the groove (150).

14. The belt buckle (100) of claim 13, wherein the handle (220) is moved by applying a force greater than and in the opposite direction of the magnetic attractive force between the blade (210) of the folding knife (200) and the groove (150).

15. The belt buckle (100) of claim 10, wherein the lever (240) of the folding knife (200), when pressed, deploys the folding knife (200) from the folded position to the opened position.

16. A belt buckle (100) configured to removably retain a folding knife (200) in a substantially concealed manner, the belt buckle (100) comprising:
a fastener (110) removably connectable to a conventional belt (300);
a first sidewall (120) and a second sidewall (130) connected at their bottom ends by a bottom wall (140);
a groove (150) formed by the connection arrangement of the first sidewall (120), the second sidewall (130), and the bottom wall (140), wherein the groove (150) is dimensioned to receive and retain the folding knife (200) in a folded position; and
wherein the groove (150) includes at least one magnet to magnetically attract a blade (210) of the folding knife (200).

17. The belt buckle (100) of claim 16, wherein the blade (210) is formed of a ferromagnetic material that's magnetically attracted to the at least one magnet of the belt buckle (100), thereby enabling the retainment of the folding knife (200) within the groove (150) of the belt buckle (100).

18. The belt buckle (100) of claim 16, wherein the fastener (110) includes a tongue (111) configured to be slidably inserted into a selective hole of the conventional belt (300) to achieve the desired tightening of the conventional belt (300) around the waist of a user.

19. The belt buckle (100) of claim 16, wherein the at least one magnet is disposed on at least one of: the first sidewall (120), the second sidewall (130), and the bottom wall (140).
